(19) United States
(12) Patent Application Publication
(10) Pub. No.: US 2006/0287061 A1
(43) Pub. Date: Dec. 21, 2006

(54) Gaming machine

(75) Inventor: Yukinori Inamura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/438,294

(22) Filed: May 23, 2006

(30) Foreign Application Priority Data
May 27, 2005 (JP) 2005-155651

(51) Int. Cl. A63F 13/00

(52) U.S. Cl. 463/20

(57) ABSTRACT

Each of the payouts is corresponded to each of thee treasure boxes 126˜128 which are elements of the bonus game displayed on the effect screen 125 in the bonus game (S11), and the payout, which is different from the payout corresponded by the bonus payout lottery table 81, is newly corresponded to two treasure boxes not selected by the player by using the display payout lottery tables 28 to 84 (S12), while taking beforehand all conceivable selection patterns into consideration. Further, after the player selects any one of the treasure boxes 126˜128, the payouts of the treasure box which is selected and the treasure boxes which is not selected are displayed, respectively (S17, S18).

### CROSS-REFERENCE TO THE RELATED APPLICATIONS (S)

This application is based upon and claims a priority from the prior Japanese Patent Application No. 2005-155651 filed on May 27, 2005, the entire contents of which are incorporated herein by reference.

### BACKGROUND OF THE INVENTION

1. Field of the Invention

The present invention relates to a gaming machine in which a second game is executed continuous to a first game if a predetermined condition of the first game is realized, in particular to a gaming machine in which it is conducted a lottery of payouts corresponding to elements, which are not specified by an element specification device among elements displayed in the second game, by utilizing a lottery device different from that used in a lottery of a payout corresponding to an element specified by the element specification device, thereby accomplishment feeling for the second game can be given to a player and motivation for the second game can be improved.

2. Description of Related Art

In a gaming machine such as a lot machine, a roulette game machine, a card game machine and the like in which coins as game media are used, a predetermined game can be started based on that the player inserts coins in the gaming machine. When the player wins the game, a predetermined number of coins are paid out from the gaming machine. And in the above gaming machine, it is general that a plural kinds of games are executed so that the game does not become monotonous. For example, there exists a gaming machine that if a predetermined condition is satisfied in a first game which is a base game, a second game which is a bonus game is conducted continuously to the first game.

And as such second game, for example, as shown in National Publication of translated version No. 2002-537874, it is conducted a game that plural elements are displayed on a display, the player selects any one of the elements and a payout result (obtainment of free games or credits) corresponded to the element which is selected is displayed.

And as in the gaming machine described in National Publication of translated version No. 2002-537874, when the bonus game selected is conducted, in order to give accomplishment feeling of a selection result to the player or to improve expectation for the next bonus game, after the element is selected by the player, a payout (namely, payout obtained by the player) corresponded to the element selected by the player and a payout corresponded to the element not selected by the player are generally informed to the player. However, for example, in a case that a payout higher than that corresponded to the element selected by the player is displayed as the payout corresponded to the element not selected by the player, it concludes that the player recognizes fail of selection. Thereby, game motivation of the player decreases. And a probability according to which a very high payout such as JP (Jack Pod) winning is selected by the player must to be set to a very low value, thus the payout corresponded to the element not selected is scarcely displayed. Therefore, game motivation of the player also decreases.

### SUMMARY OF THE INVENTION

In order to dissolve the above problems, the present invention has an object to provide a gaming machine in which the payout corresponded to the element not selected by the player among the elements displayed in the second game is displayed by using a payout for display (display payout) determined by a lottery manner different from the lottery manner of the payout which is actually obtained by the player, thereby accomplishment feeling for the second game can be given to the player and game motivation can be improved.

In order to accomplish the above object, according to one aspect of the present invention, it is provided a gaming machine comprising:

an image display device for displaying images thereon;

an operation device;

a first game control device for controlling a first game;

a second game control device for executing a second game which is executed continuous to the first game when a predetermined condition is realized in the first game;

wherein the second game control device comprises:

an element display device for displaying plural elements on the image display device;

an element specification device for specifying the element among plural elements displayed on the image display device based on an operation of the operation device;

a first payout lottery device for conducting a lottery of the payouts corresponding to the elements displayed on the image display device by using a first lottery manner;

a first element payout display device for displaying on the image display device the payout corresponding to the element specified through the element specification device based on a lottery result of the first payout lottery device;

a second payout lottery device for conducting a lottery of the payouts corresponding to the elements not specified through the element specification device by using a second lottery manner different from the first lottery manner;

a second element payout display device for displaying on the image display device the payouts corresponding to the elements not specified through the element specification device based on a lottery result of the second payout lottery device; and

an award giving device for giving an award corresponding to the payout displayed on the image display device through the first element payout display device.

Here, “payout” means an award which is given to a player through the award giving device, and for example, “payout” means payment of game media corresponding to 50 credits, winning of JP (Jack Pot), obtainment of 10 free games and so on.

And “difference between the first lottery manner and the second lottery manner” means that kinds of the payouts given by the lottery become different or a probability to win each of the payouts becomes different. For example, there will be a case that a lottery table used in the first lottery manner is different from a lottery table used in the second lottery manner.

Further, “first payout lottery device” may determine plural kinds of payouts every element and the payout may become different corresponding to the element which is specified. And “first payout lottery device” may determine the payout fixedly corresponding to the element in spite of the kind of the element specified through the element specification device.

And a timing of the lottery by “second payout lottery device” may be set after the element is specified or before the element is specified.

According to the gaming machine of the present invention, among the elements displayed in the second game, the lottery of the payout of the element specified through the element specification device is conducted by the first payout lottery device and the lottery of the payout of the elements not specified through the element specification device is conducted by the second payout lottery device, and the payout corresponding to each of the elements is displayed based on the lottery results by the first and the second lottery devices. Thereby, as for the payouts corresponding to the elements not selected by the player, it can make the player recognize as if the payout for displaying (display payout), which is displayed later, is corresponded to the elements beforehand at the time that the players selects the element. Therefore, the display payouts of the elements not selected by the player can be displayed as the payouts (for example, the payout with very expensive value or the payout lower than the payout that the player selects) different from the payouts that the player can, in fact, obtain, as a result, accomplishment feeling for the second game can be given to the player and game motivation of the player can be improved.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view of a slot machine according to the first embodiment,

FIG. 2 is a front view showing an inner construction of a cabinet of the slot machine according to the first embodiment,

FIG. 3 is an explanatory view schematically showing symbol columns which are variably displayed in variable display portions,

FIG. 4 is a schematic view showing a base game lottery table of the slot machine according to the first embodiment,

FIG. 5 is a schematic view showing a base game payout table of the slot machine according to the first embodiment,

FIG. 6 is a block diagram schematically showing a control system of the slot machine according to the first embodiment,

FIG. 7 is a block diagram schematically showing a liquid crystal drive circuit of an upper liquid crystal display and a lower liquid crystal display,

FIG. 8 is a schematic view showing a bonus payout lottery table and display payout lottery tables of the slot machine according to the first embodiment,

FIG. 9 is a flowchart of a main process program of the slot machine according to the first embodiment,

FIG. 10 is a flowchart of a bonus process program of the slot machine according to the first embodiment,

FIG. 11 is an explanatory view showing an effect screen of a bonus game displayed on the lower liquid crystal display after the bonus game is started,

FIG. 12 is an explanatory view showing an effect screen of the bonus game displayed on the lower liquid crystal display, treasure boxes as elements being displayed on the effect screen in the bonus game,

FIG. 13 is an explanatory view showing an effect screen of the bonus game, payouts corresponding to the treasure boxes selected by a player being displayed on the effect screen,

FIG. 14 is an explanatory view showing an effect screen of the bonus game, payouts corresponding to the treasure boxes not selected by the player being displayed on the effect screen,

FIG. 15 is an explanatory view showing a display payout lottery table of the slot machine according to the second embodiment, and

FIG. 16 is an explanatory view showing an effect screen of the bonus game, payouts corresponding to the treasure boxes not selected by the player being displayed on the effect screen, in the slot machine according to the second embodiment.

### DETAILED DESCRIPTION OF THE PREFERRED EMBODIMENTS

Hereinafter, a gaming machine according to the present invention will be described based on the first and the second embodiments, in each of which the gaming machine of the present invention is embodied in a slot machine, with reference to the drawings.

### First Embodiment

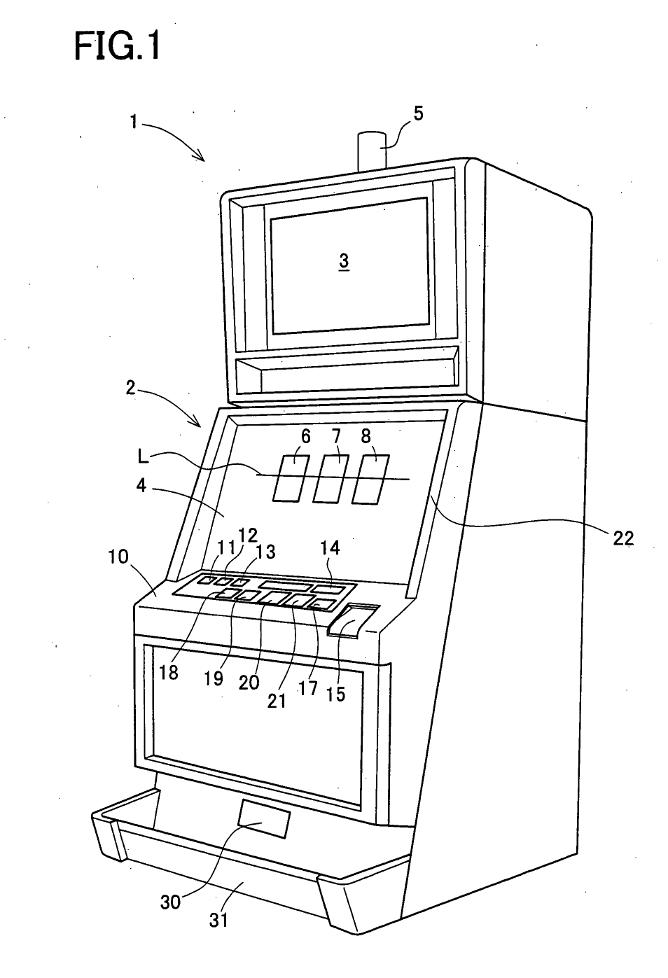

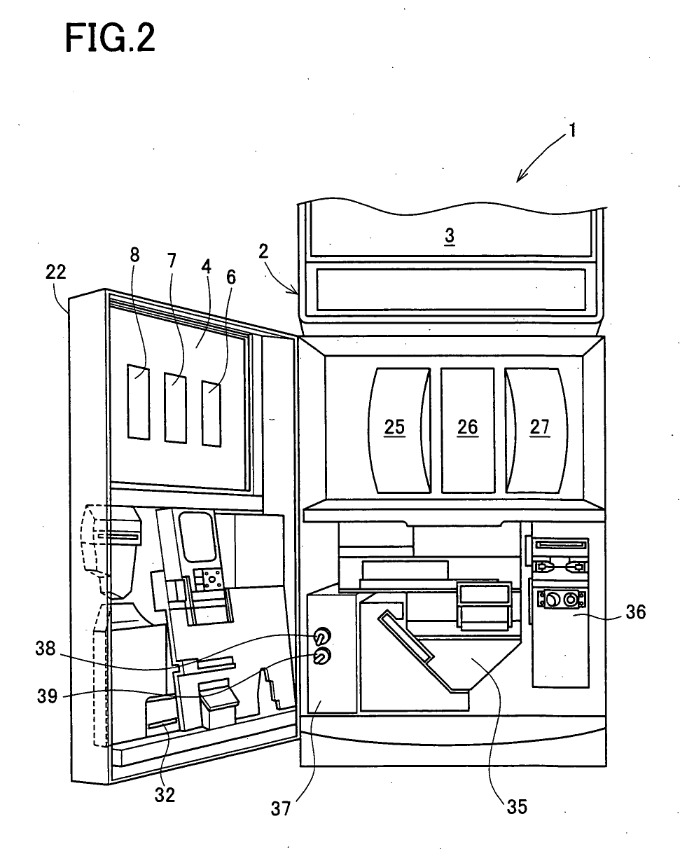

At first, an outline construction of a slot machine 1 according to the first embodiment will be described with reference to FIGS. 1 and 2. FIG. 1 is a perspective view of the slot machine according to the first embodiment, and FIG. 2 is a front view showing an inner construction in a cabinet of the slot machine according to the first embodiment.

In FIG. 1, the slot machine 1 has a cabinet 2 forming whole construction thereof. And at an upper position of the cabinet 2, an upper liquid crystal display 3 is arranged, and at a front central position of the cabinet 2, a lower liquid crystal display 4 is arranged. Here, the upper liquid crystal display 3 is constructed from a liquid crystal display which is used for general purpose, and the lower liquid crystal display 4 is constructed from a, so-called, transparent liquid crystal display. On the upper liquid crystal display 3, help information for assisting game operations such as a game method, kinds of winning symbol combinations and payouts thereof and for conducting various effects concerning with the game is displayed. Further, on an upper position of the upper liquid crystal display 3, it is provided a lamp 5 which is turned on when error occurs and the player calls a shop assistant.

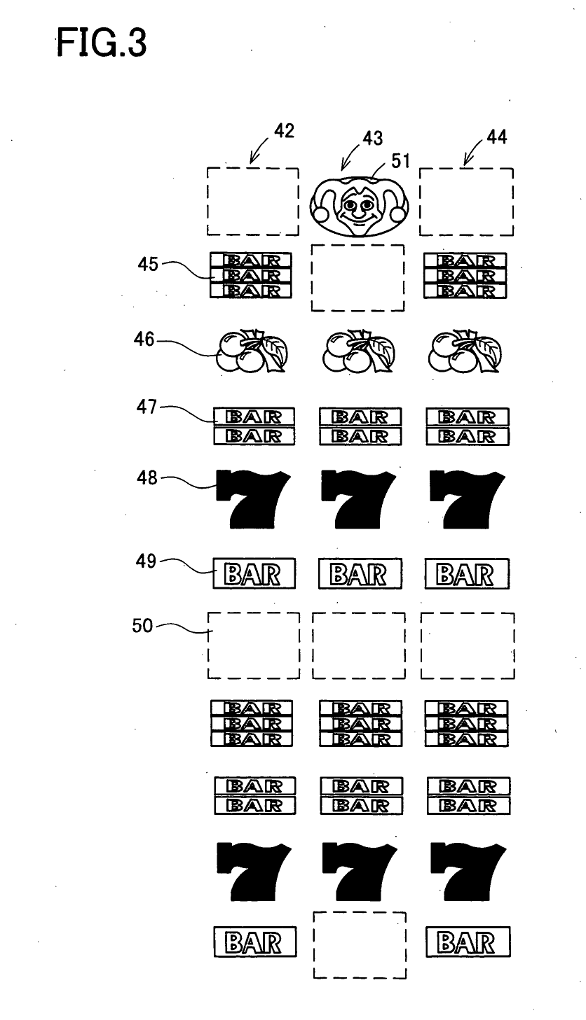

Further, on the lower liquid crystal display 4, as shown in FIG. 1, three variable display portions 6, 7 and 8 are basically displayed. On each of the variable display portions 6, 7 and 8, various symbols are variably displayed while scrolling from an upper position toward a lower position. Here, since the construction of transparent liquid crystal display is already well-known (for example, see phrases (0019)˜(0022), FIGS. 2 and 3 in Unexamined Japanese Publication No. 2005-13356), explanation thereof will be omitted.

At a lower side of the lower liquid crystal display 4, a control panel 10, which is projected forward, is provided. On this control panel 10, when seeing from the position facing to the front plane of the gaming machine 1, there are provided from the left side thereof a change button 11 for calling a shop assistant in order to exchange cash with coins, a cashout button 12 for cashing out coins corresponding to amount of credits and a help button 13 for displaying a help screen including various kinds of help information. And at the right side of the help button 13, a coin insertion slot 14 and a bill insertion portion 15 are provided. Further, from the left side on a forward position of the control panel 11, there are arranged a 1-BET button 18, a REPEAT BET button 19, a 10-BET button 20, a MAXBET button 21 and a start button 17 for starting variable display of the symbols.

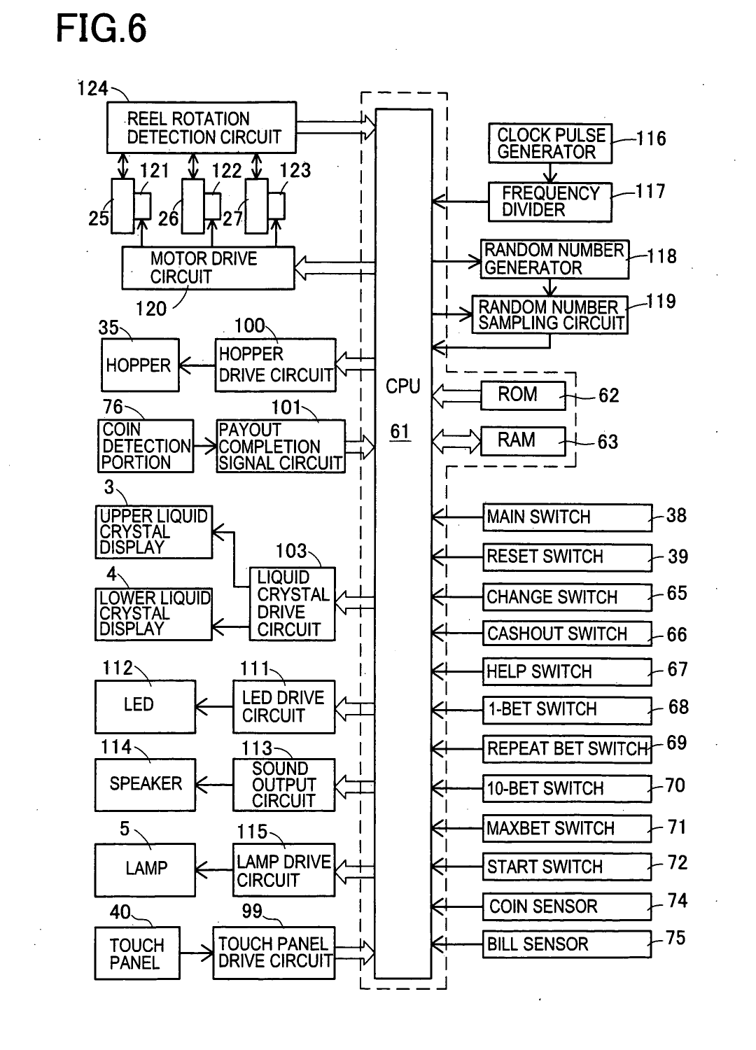

And at a lower side of the cabinet 2, a coin payout opening 30 is formed and it is provided a coin receiver 31 for receiving coins (for example, one dollar coins) paid out from the coin payout opening 30 when the cashout button 12 is pressed. Within the coin payout opening 30 a coin detection portion 76 (see FIG. 6) constructed from a sensor is arranged, and this coin detection portion 76 detects coins paid out from the coin payout opening 30. Here, as the payout device of game media, it may be conceivable that a receipt on which the value of game media accumulated at present is described, is discharged instead of direct payout of coins.

And as shown in FIG. 2, at the center position of the cabinet 2 in a state that a device front panel 22 arranged to the front plane of the cabinet 2 is opened, reels 25, 26, 27 are rotatably provided. And on a peripheral surface of each of these reels 25, 26, 27, a symbol column (see FIG. 3) constructed from a plurality of symbols is described.

Further, at the left side of a hopper 35 within the cabinet 2, a bill validator 36 for distinguishing bills inserted from the bill insertion portion 15 and a power box unit 37 are provided. On the front plane of the power box unit 37, there are provided a main switch 38 through which power supply necessary for the slot machine 1 to operate is switched on and off and a reset switch 39 for initializing the state of the slot machine 1.

Next, the reels rotatably provided within the cabinet 2 at the rear side of the lower liquid crystal display 4 will be described.

At the rear side of the lower liquid crystal display 4, as shown in FIG. 2, three reels 25 to 27 are supported in a parallel relation so that each of the reels 25 to 27 is able to independently rotate. By using reels 25 to 27, a base game (first game, mentioned later) is conducted. And among three reels 25 to 27, when seeing from the front plane of the slot machine 1, the left reel 25 faces to a variable display portion 6 (see FIGS. 1 and 2) formed in the lower liquid crystal display 4, the center reel 26 faces to a variable display portion 7 (see FIGS. 1 and 2) similarly formed in the lower liquid crystal display 4 and the right reel 27 (see FIGS. 1 and 2) faces to a variable display portion 8 (see FIGS. 1 and 2) similarly formed in the lower liquid crystal display 4.

Next, with reference to FIG. 3, it will be described symbol columns each of which is described on the peripheral surface of each of the reels 25 to 27 and are variably displayed based on rotation of the reels 25 to 27 while scrolling in each of the variable display portions 6 to 8. FIG. 3 is a schematic view showing each of the symbol columns described on the reels 25 to 27.

In FIG. 3, a symbol column 42 is a symbol column which is variably displayed in the variable display portion 6, a symbol column 43 is a symbol column which is variably displayed in the variable display portion 7 and a symbol column 44 is a symbol column which is variably displayed in the variable display portion 8.

Here, as for formation of various symbols on the peripheral surface of each of the reels 25 to 27, it is a general method that the symbols are printed on a long reel sheet having a width and a length each of which coincides with a width and a peripheral length of each of the reels 25 to 27, and such reel sheet is adhered on the peripheral surface of each of the reels 25 to 27. However, such symbols may be, of course, formed by methods other than the above method.

Here, the symbol column 42 and the symbol column 44 commonly have the same symbol arrangement, and each of the symbol columns 42, 44 is constructed from eleven symbols by voluntarily combining a triple BAR 45, a cherry 46, a double BAR 47, a seven 48, a single BAR 49 and a blank (area in which no symbol exists) 50.

And although the symbol column 43 is as same as the symbol columns 42, 44 at the point that the triple BAR 45, the cherry 46, the double BAR 47, the seven 48, the single BAR 49, the blank 50 are combined, the symbol column 43 is different from the symbol columns 42, 44 at the point that a trigger symbol 51 is further arranged. This trigger symbol 51 is a symbol to shift the game state to a bonus game, and in a case that the trigger symbol 51 is stopped and displayed on a pay line L in the variable display portion 7, the game state can shift to a bonus game (second game) continuous to the base game.

Here, the bonus game is a game which is continuously conducted after the base game is conducted, and such bonus game becomes beneficial to a player in many cases. In the slot machine 1 according to the first embodiment, a plurality of elements are displayed on the lower liquid crystal display 4 and thereafter it is conducted a selective bonus game which gives to the player a payout corresponding to the element selected by the player.

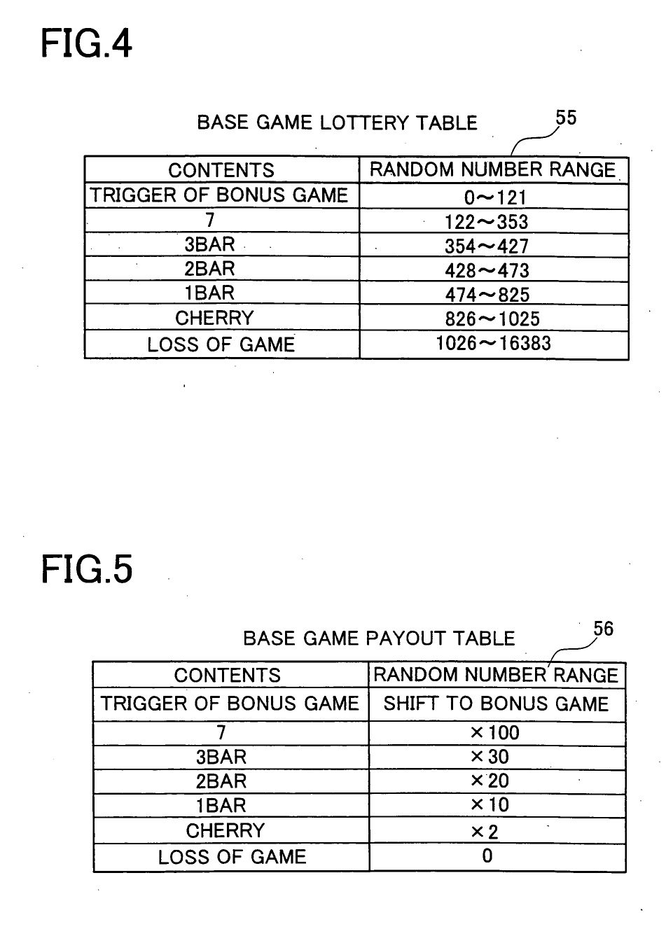

And in a case that the symbol columns 42 to 44 scrolled in the variable display portions 6 to 8 are stopped and displayed, three symbols are stopped and displayed in each of the variable display portions 6 to 8. At that time, the symbols stopped and displayed are determined based on an internal lottery result (mentioned later) obtained by using a base game lottery table 55 shown in FIG. 4, and the reels 25 to 27 are controlled and stopped based on such lottery result.

Further, various winning symbol combinations are preset based on various kinds of symbol combinations, and when the symbol combination corresponding to the winning symbol combination in a base game payout table shown in FIG. 5 is stopped on the pay line L (see FIG. 1), credits are added corresponding to the winning symbol combination. In particular, as shown in FIGS. 4 and 5, if a random number value sampled by a random number sampling circuit 119 mentioned later (see FIG. 6) lies in a range of 0˜121, the trigger of the bonus game is won. In this case, the trigger symbol 51 is stopped and displayed on the pay line L within the variable display portion 7, thereby the game state shifts to the bonus game.

Next, a construction of a control system of the slot machine will be described with reference to FIG. 6. FIG. 6 is a block diagram schematically showing the control system of the slot machine according to the first embodiment.

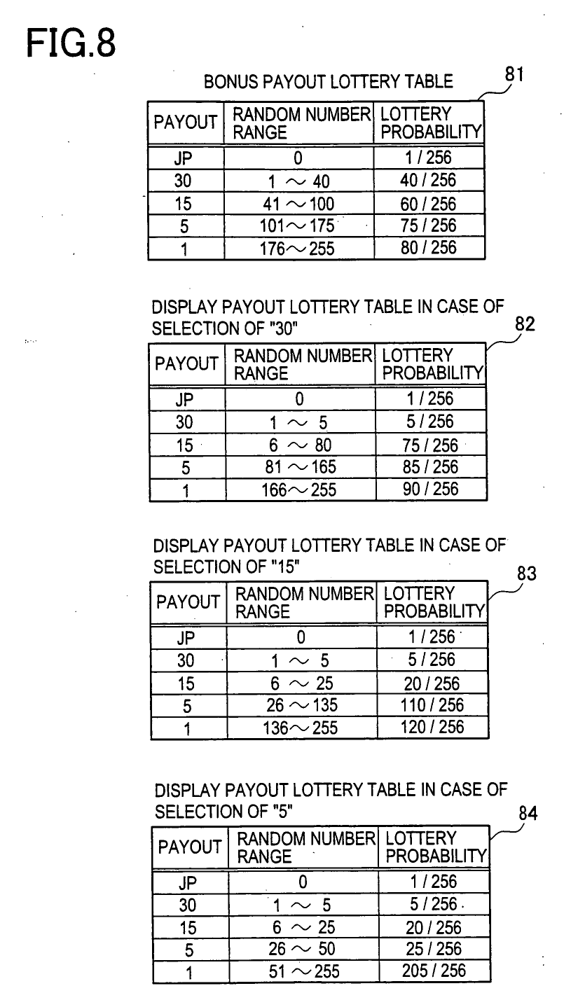

In FIG. 6, the control system of the slot machine 1 is basically constructed from a CPU 61, and a ROM 62 and a RAM 63 are connected to the CPU 61. In the ROM 62, there are stored a main process program mentioned later, a base game process program, a bonus game process program, various effect process programs for conducting various effects on the upper liquid crystal display 3 and the lower liquid crystal display 4 according to progress of the game, a base game lottery table 55 (see FIG. 4) for conducting a lottery of the stop display symbols in the base game, a base game payout table 56 (see FIG. 5) according to which a payout is determined based on the winning symbol combination in the base game, a bonus game payout lottery table 81 (see FIG. 8) for conducting a lottery of the payout corresponding to the element selected in the bonus game, a display payout lottery tables 82˜84 (see FIG. 8) for conducting a lottery of the display payouts corresponding to the elements not selected in the bonus game, other various programs necessary for control of the slot machine 1 and data tables. And the RAM 63 is a memory to temporarily store a credit number which the player holds at present and various data calculated by the CPU 61.

And to the CPU 61, a clock pulse generator circuit 116 producing standard clock pulses and a frequency divider 117 are connected, and a random number generator 118 producing random numbers and a random number sampling circuit 119 are connected. The random number sampled through the random number sampling circuit 119 is used for various lotteries of the winning symbol combination and effect. Further, to the CPU 61, there are connected the main switch 38, the reset switch 39, a change switch 65 attached to the change button 11, a cashout switch 66 attached to the cashout button 12, a help switch 67 attached to the help button 13, a 1-BET switch 68 attached to the 1-BET button 18, a REPEAT BET switch 69 attached to the REPEAT BET button 19, a 10-BET switch 70 attached to the 10-BET button 20, a MAXBET switch 71 attached to the MAXBET button 21 and a start switch 72 attached to the start button 17. The CPU 61 conducts control to execute various operations corresponding thereto based on a switch signal output from each switch on the basis of press of each button.

To the CPU 61, three stepping motors 121 to 123 for rotating the reels 25 to 27 through a motor drive circuit 120 are connected, and a reel position detection circuit 124 is also connected to the CPU 61. When a motor drive signal is output from the CPU 61 to the motor drive circuit 120, each of the stepping motors 121 to 123 is driven to rotate through the motor drive circuit 120. Thereby, each of the reels 25 to 27 is rotated.

And the CPU 61 counts a step number of each of the stepping motors 121 to 123 which are driven to rotate, and if the step number reaches to a predetermined count value which is preset based on a lottery result of the winning symbol combination, rotation of each of the stepping motors 121 to 123 each step number of which reaches to the count value is stopped. Thereby, the symbol combination corresponding to the winning symbol combination is stopped and displayed on the pay line L.

And to the CPU 61, a reel rotation detection circuit 124 for detecting illegal rotation of the reels 25 to 27 is connected. The reel rotation detection circuit 124 detects a fin (not shown) provided with a predetermined distance within each of the reels 25 to 27 through a reflection-type optical sensor (not shown) individually arranged at the side position of each reel. Thereby, the reel rotation detection circuit 124 detects whether or not each reel is illegally rotated after rotation of the reels 25 to 27 is stopped.

Further, to the CPU 61, a coin sensor 74 arranged in the coin insertion slot 14 and a bill sensor 75 arranged in the bill insertion portion 15 are connected, respectively. The coin sensor 74 detects coins inserted from the coin insertion slot 14 and the CPU 61 calculates a number of coins inserted on the basis of the coin detection signal output from the coin sensor 74. The bill sensor 75 detects the kind and sum of bill inserted from the bill insertion portion 15 and the CPU 61 calculates a number of coins equivalent to the sum of bill on the basis of the bill detection signal output from the bill sensor 75.

To the CPU 61, a hopper 35 is connected through a hopper drive circuit 100. When a drive signal is output to the hopper drive circuit 100 from the CPU 61, the hopper 35 pays out a predetermined number of coins from the coin payout opening 30.

And to the CPU 61, a coin detection portion 76 is connected through a payout completion signal circuit 101. The coin detection portion 76 is arranged within the coin payout opening 30, and if it is detected that the predetermined number of coins are paid out from the coin payout opening 30, a coin payout detection signal is output to the payout completion signal circuit 101 from the coin detection portion 76. Based on this, the payout completion signal circuit 101 outputs a payout completion signal to the CPU 61. Further, to the CPU 61, the upper liquid crystal display 3 and the lower liquid crystal display 4 are connected through a liquid crystal drive circuit 103, and both of the upper liquid crystal display 3 and the lower liquid crystal display 4 are controlled by the CPU 61.

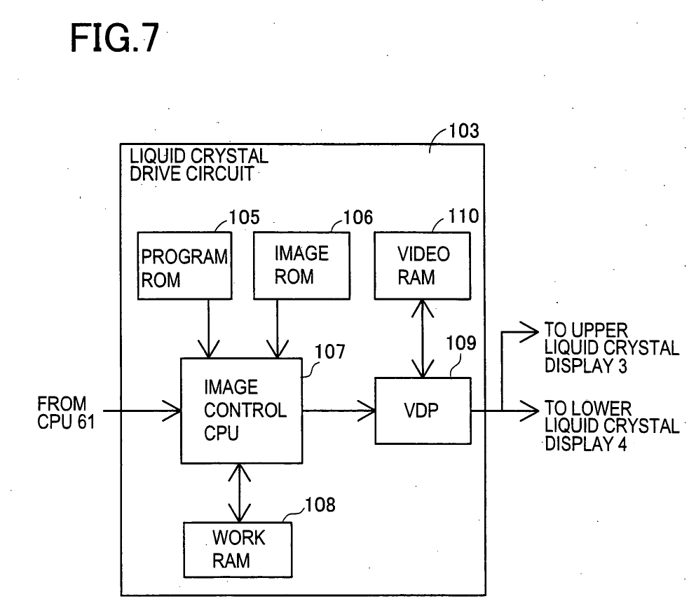

Here, as shown in FIG. 7, the liquid crystal drive circuit 103 is constructed from a program ROM 105, an image ROM 106, an image control CPU 107, a work RAM 108, a VDP (Video Display Processor) 109 and a video RAM 110. And in the program ROM 105, there are stored an image control program concerning with display on the upper liquid crystal display 3 and the lower liquid crystal display 4 and various selection tables. And in the image ROM 106, for example, it is stored dot data for forming images, such as treasure boxes 126 to 128 (see FIG. 12), displayed on the upper liquid crystal display 3 and the lower liquid crystal display 4 in the bonus game. And the image control CPU 107 determines images displayed on the upper liquid crystal display 3 and the lower liquid crystal display 4 among the dot data stored beforehand in the image ROM 106, according to the image control program stored in the program ROM 105 based on parameters set by the CPU 61. And the work RAM 108 is constructed as a temporary memory when the image control program is executed by the image control CPU 107. Further, the VDP 109 forms images corresponding to display contents determined by the image control CPU 107 and outputs them to the upper liquid crystal display 3 and the lower liquid crystal display 4. Here, the video RAM 110 is constructed as a temporary memory when the images are formed by the VDP 109.

And to the CPU 61, a LED 112 is connected through a LED drive circuit 111. Many LEDs 112 are arranged on the front plane of the slot machine 1 and are controlled to turn on and off through the LED drive circuit 111 based on the drive signal from the CPU 61 when various effects are conducted. And a sound output circuit 113 and a speaker 114 are connected to the CPU 61 and the speaker 114 produces various effect sounds when various effects are conducted based on the output signal from the sound output circuit 113. Further, a lamp drive circuit 115 and a lamp 5 are connected to the CPU 61 and the lamp 5 is turned on based on the output signal from the lamp drive circuit 115.

And to the CPU 61, a transparent touch panel 40 is connected through a touch panel drive circuit 99. The transparent touch panel 40 is provided on the screen of the lower liquid crystal display 4, and by using the transparent touch panel 40, it can be determined through the touch panel drive circuit 99 where the player touches and to which direction the touched place is moved, based on coordinate position information of the place touched by the player.

Therefore, when the player selects the element having a treasure box shape displayed on the lower liquid crystal display 4 as shown in FIG. 12, the CPU 61 utilizes the transparent touch panel 40 and the touch panel drive circuit 99, thereby the position to which the player touches (treasure boxes 126 to 128 one of which is selected by the player) can be determined.

Next, a bonus payout lottery table 81 used in the lottery of the bonus game and a display payout lottery tables 82 to 84 will be described. FIG. 8 is an explanatory view showing the bonus payout lottery table 81 and the display payout lottery tables 82 to 84 which are used in the lottery of the bonus game in the slot machine 1.

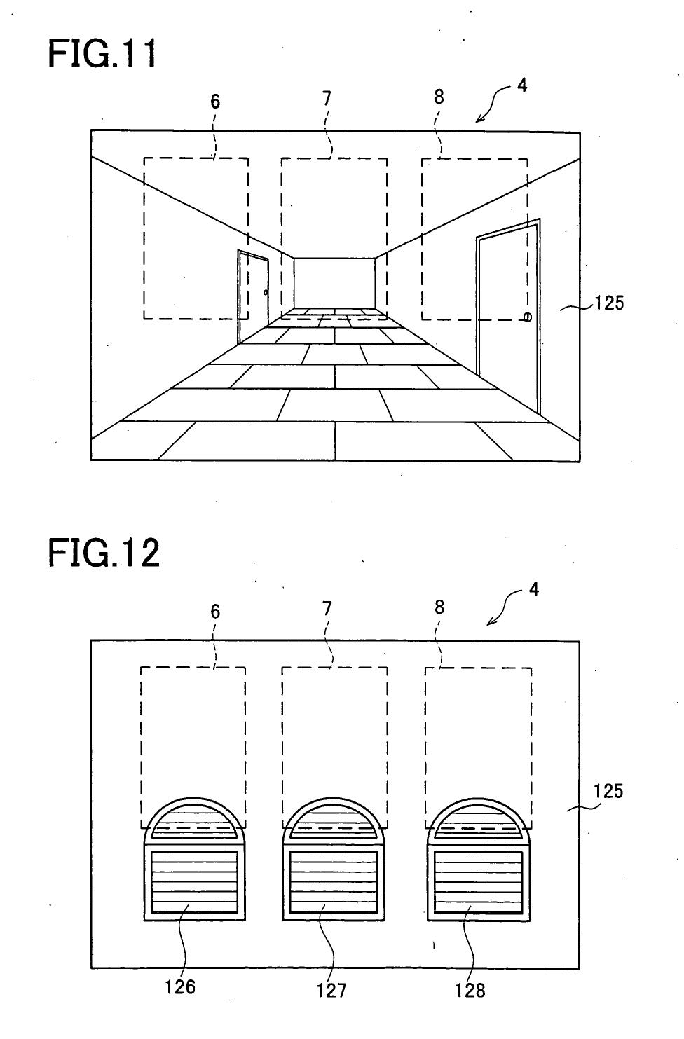

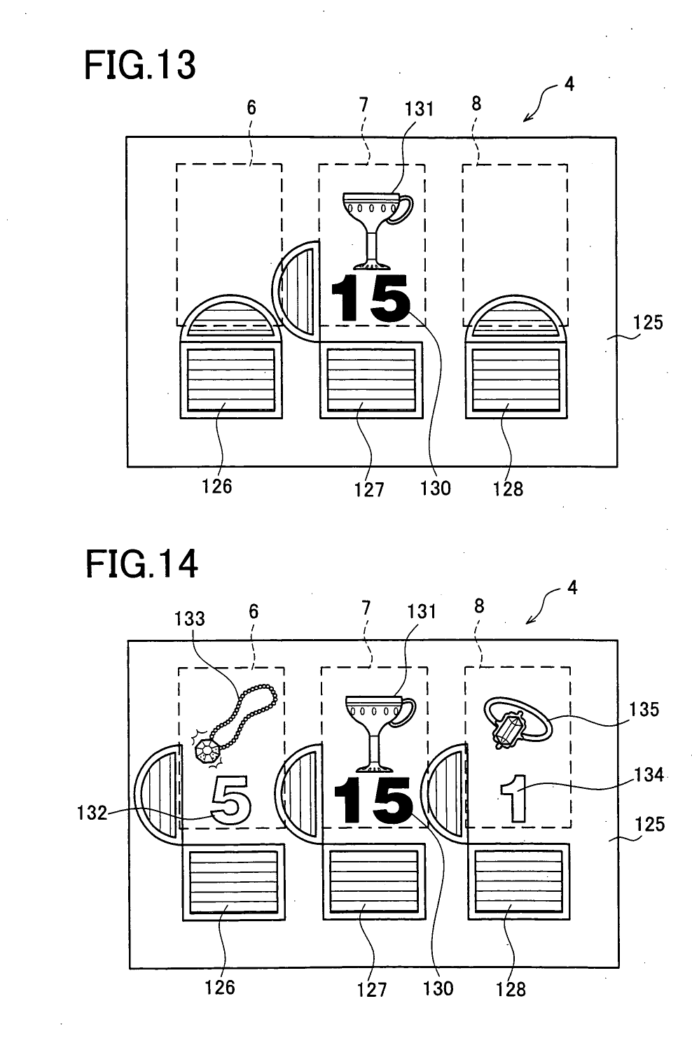

Here, as mentioned in the above, the bonus game is a special game which is shifted from the base game when the trigger symbol 51 is stopped and displayed on the pay line L in the variable display portion 7 in the base game. In the bonus game, the symbol columns 42 to 44 are not displayed and the bonus game is progressed by displaying images whole screen of the lower liquid crystal display 4 (see FIGS. 11 to 14). Concretely, three treasure boxes 126 to 128 as the elements are displayed on the lower liquid crystal display 4 (see FIG. 12), thereafter when the player selects any one of the treasure boxes (for example, center treasure box 127), the payout corresponding to the treasure box selected is displayed (see FIG. 13), thereby credits corresponding to the payout are paid out to the player. Further, payouts of the treasure boxes not selected (for example, left treasure box 126 and the right treasure box 128) are also displayed (see FIG. 14).

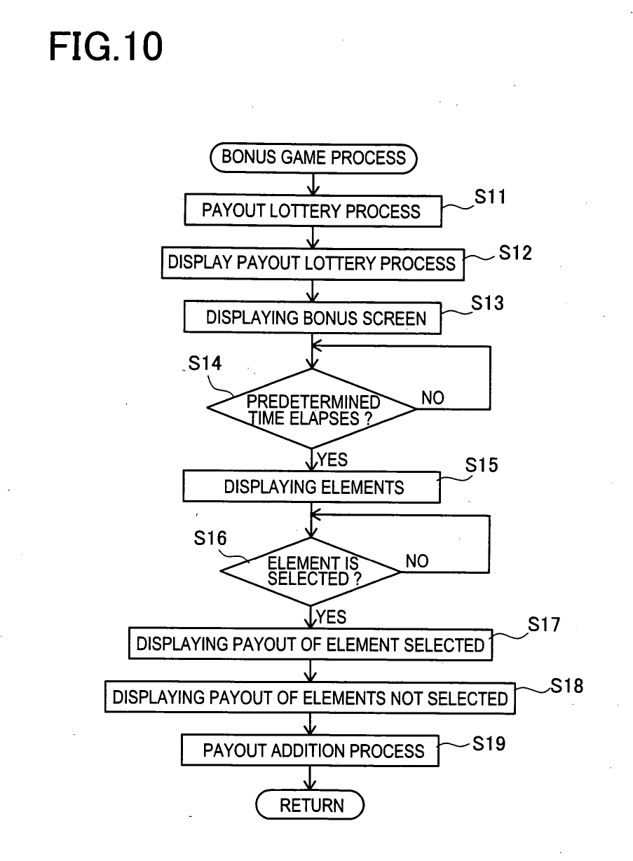

Here, the bonus payout lottery table 81 is a table to correspond each of the payouts with each of the treasure boxes 126 to 128 displayed as the elements on the lower liquid crystal display 4. In the bonus payout lottery table 81, as shown in FIG. 8, five payouts of “JP (Jack Pot)”, “30 (credits)”, “15 (credits)”, “5 (credits)” and “1 (credit)” are stored. And for each of the payouts, a random number value range with a predetermined value range is set. And as mentioned later, the CPU 61 samples three random number values through the random number sampling circuit 119 so as to correspond to each of the treasure boxes 126 to 128 and determines the payout for each of the treasure boxes (see S11 in FIG. 10).

For example, if the random number value sampled through the random number sampling circuit 119 is “0”, the payout of “JP” according to which the payout of “JP” is conducted is corresponded to the treasure box. Here, “JP” is a specific payout according to which game media corresponding to the value calculated by accumulating with a predetermined ratio (for example, 3%) the value of game media betted in plural slot machines including the slot machine 1 are paid out. Thereby, the player can get the payout with enormous game media.

And if the random number value sampled through the random number sampling circuit 119 lies in a range of “1˜40”, the payout of “30” according to which 30 credits are paid out is corresponded to the treasure box.

And if the random number value sampled through the random number sampling circuit 119 lies in a range of “41˜100”, the payout of “15” according to which 15 credits are paid out is corresponded to the treasure box.

And if the random number value sampled through the random number sampling circuit 119 lies in a range of “101˜175”, the payout of “5” according to which 5 credits are paid out is corresponded to the treasure box.

And if the random number value sampled through the random number sampling circuit 119 lies in a range of “176˜255”, the payout of “1” according to which one credit is paid out is corresponded to the treasure box.

On the other hand, each of the display payout lottery tables 82 to 84 is a table to newly correspond the payout (concretely, the display payout to display the payout different from the payout obtained when the treasure box is selected) different from the payout, which is corresponded in the bonus payout lottery table 81, with each of the treasure boxes as the elements not selected by the player. Here, in the first embodiment, the display payout lottery tables 82 to 84 are constructed from three kinds of tables, and the table used in the lottery is made different according to which of treasure boxes 126˜128, each being corresponded to any one of the payouts, is selected in the bonus game by the player.

For example, the display payout lottery table 82 is a table used in the lottery when the player selects the treasure box 126˜128 corresponded to the payout of “30” in the bonus game. And if the random number value sampled through the random number sampling circuit 119 is “0”, the payout at the time that the treasure box is selected is changed and displayed as if the payout of “JP” is corresponded to such selected treasure box.

And if the random number value sampled through the random number sampling circuit 119 lies in a range of “1˜5”, the payout at the time that the treasure box is selected is changed and displayed as if the payout of “30” is corresponded to such selected treasure box.

And if the random number value sampled through the random number sampling circuit 119 lies in a range of “6˜80”, the payout at the time that the treasure box is selected is changed and displayed as if the payout of “15” is corresponded to such selected treasure box.

And if the random number value sampled through the random number sampling circuit 119 lies in a range of “81˜165”, the payout at the time that the treasure box is selected is changed and displayed as if the payout of “5” is corresponded to such selected treasure box.

Further, if the random number value sampled through the random number sampling circuit 119 lies in a range of “166˜255”, the payout at the time that the treasure box is selected is changed and displayed as if the payout of “1” is corresponded to such selected treasure box.

Similarly to the above, the display payout lottery table 83 shown in FIG. 8 is a table used in the lottery when the player selects the treasure box 126˜128 corresponded to the payout of “15” in the bonus game. And the display payout lottery table 84 is a table used in the lottery when the player selects the treasure box 126˜128 corresponded to the payout of “5” in the bonus game. The detail contents thereof are shown in FIG. 8.

And as for the display payout corresponded to the treasure box 126˜128 in the display payout lottery table 82, in particular, a probability corresponding to each of the payouts of “15”, “5”, “1” is respectively raised such as 60/256→75/256, 75/256→85/256, 80/256→90/256. Therefore, it can be displayed as if the payout further lower than the payout of “30” corresponding to the treasure box selected by the player is corresponded to the other treasure box at the time that the treasure box is selected, thus it can make the player recognize that the treasure box selected by himself/herself corresponds to the element with high payout. Thereby, accomplishment feeling of the player in the bonus game can be improved.

And as for the display payout corresponded to the treasure box 126˜128 in the display payout lottery table 83, in particular, a probability corresponding to each of the payouts of “5”, “1” is respectively raised such as 75/256→110/256, 80/256→120/256. Therefore, it can be displayed as if the payout further lower than the payout of “15” corresponding to the treasure box selected by the player is corresponded to the other treasure box at the time that the treasure box is selected, thus it can make the player recognize that the treasure box selected by himself/herself corresponds to the element with high payout. Thereby, accomplishment feeling of the player in the bonus game can be improved.

And as for the display payout corresponded to the treasure box 126˜128 in the display payout lottery table 84, in particular, a probability corresponding to the payout of “1” is raised such as 80/256→205/256. Therefore, it can be displayed as if the payout further lower than the payout of “5” corresponding to the treasure box selected by the player is corresponded to the other treasure box at the time that the treasure box is selected, thus it can make the player recognize that the treasure box selected by himself/herself corresponds to the element with high payout. Thereby, accomplishment feeling of the player in the bonus game can be improved.

Here, when the player selects the treasure box 126˜128 corresponded to the payout of “JP”, the player obtains the highest payout, therefore the lottery of the display payout is not conducted and the payout corresponded by the bonus payout lottery table 81 is directly displayed. On the other hand, when the player selects the treasure box 126˜128 corresponded to the payout of “1”, the payout lower than such payout of “1” cannot be displayed as the payout of the other treasure box. Therefore, similarly to the above, the lottery of the display payout is not conducted and the payout corresponded by the bonus payout lottery table 81 is directly displayed.

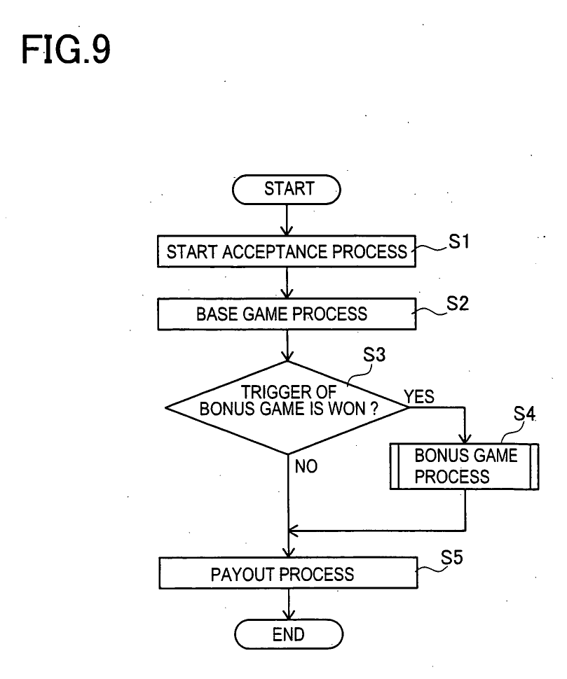

Next, the main process program executed in the slot machine 1 will be described with reference to FIG. 9. FIG. 9 is a flowchart of the main process program executed in the slot machine 1 according to the first embodiment. Here, each of programs respectively shown in FIGS. 9 and 10 is stored in the ROM 62 and the RAM 63 provided in the slot machine 1 and is executed by the CPU 61.

At first, in step (hereinafter, abbreviated as “S”) 1, a start acceptance process is conducted. In the start acceptance process, it is conducted the process to accept the switch signal output from the start switch 72, the REPEAT BET switch 69, the 1-BET switch 68, the 10-BET switch 70 or the MAXBET switch 71, based on operation of the start button 17, the REPEAT BET button 19, the 1-BET button 18, the 10-BET button 20 or the MAXBET button 21, while demonstration images are displayed on the lower liquid crystal display 4. And at the time that the switch signal output from the REPEAT BET switch 69, the MAXBET switch 71 or the start switch 72 is accepted, a bet number is confirmed and display of the demonstration images is terminated, thereafter the game is started.

Next in S2, the base game process is executed. In the base game process, at first, the lottery of winning symbol combination is conducted by using the random number value sampled through the random number sampling circuit 119 and the base game lottery table 55 (see FIG. 4), and the winning symbol combination in the base game and the symbols stopped and displayed on the pay line L are determined. Thereafter, the reels 25 to 27 are driven to rotate and scroll of each of the symbols is conducted in each of the variable display portions 6 to 8, and after a predetermined time elapses each of the symbol columns is stopped in order based on the lottery result. Here, at that time, since the variable display portions 6 to 8 are made transparent, scroll of the symbols which are arranged on the reels 25 to 27 can be seen and recognized.

Thereafter, according to the symbol combination corresponding to the winning symbol combination stopped and displayed on the pay line L, the payout which is preset based on the base game payout table 56 in FIG. 5 is stored. The stored payout is paid out in a payout process of S5, with a bonus game payout if the bonus game is conducted.

Next, in S3, it is determined on the basis of the lottery result obtained in S2 in the base game whether or not the trigger of the bonus game is won.

As a result, if it is determined that the trigger of the bonus game is not won (S3: NO), the main process is terminated, and on the other hand, if it is determined that the trigger of the bonus game is won (S3: YES), the bonus game process is executed continuous to the base game (S4).

Thereafter, in S5, it is conducted the payout process in which credits corresponding to the payout stored and added in the base game process in S3 and in the bonus game process in S4 are paid out. In the payout process, in a case that the bonus game is not conducted, credits corresponding to the payout of the base game are paid out, and if the bonus game is conducted, credits corresponding to the payout in the bonus game are paid out with the payout in the base game. And after the payout process is done, the main process is terminated.

Next, the bonus game process conducted in the slot machine 1 will be described with reference to FIG. 10. FIG. 10 is a flowchart of the bonus game process executed in the slot machine 1 according to the first embodiment.

In the bonus game process, at first, in S11, a payout lottery process of the bonus game is conducted.

The payout lottery process in the bonus game is a process to allot a predetermined payout (any of “JP”, “30”, “15”, “5”, “1”) to three treasure boxes 126˜128 (see FIG. 12) which are the elements of the bonus game displayed on an effect screen 125 of the bonus game. And the player selects any one of the treasure boxes 126˜128 displayed, thereby the player can obtain the payout allotted to the treasure box 126˜128 which is selected.

Next, in S12, a display payout lottery process of the bonus game is conducted. In the display payout lottery process of the bonus game, the payout (concretely, the display payout to display the payout different from the payout obtained when the treasure box is selected) different from the payout, which is corresponded in the bonus payout lottery table 81 in S11, is newly corresponded with each of two treasure boxes especially not selected by player among three treasure boxes 126˜128 which are the elements of the bonus game later displayed on the effect screen 125 of the bonus game. And when the payouts of the treasure boxes not selected is displayed later, the payouts newly corresponded in S12 are displayed without displaying the payout corresponded in S11.

Hereinafter, the payout lottery process in S11 and the display payout lottery process in S12 will be respectively described. First, in the payout lottery process in S11, three random number values are sampled through the random number sampling circuit 119 and the payout (any of “JP”, “30”, “15”, “15”, “1”) is respectively allotted to each of the treasure boxes 126˜128 (see FIG. 12 and displayed later) by using the random number values sampled and the bonus payout lottery table 81 (see FIG. 8). For example, if the random number value sampled is “31”, “50”, “224” in order, the payout of “30” according to which 30 credits are paid out is corresponded to the first treasure bo 126, the payout of “15” according to which 15 credits are paid out is corresponded to the second treasure box 127 and the payout according to which “1” credit is paid out is corresponded to the third treasure box 128.

And in the display payout lottery process in S12, although the lottery of the payouts corresponding to two treasure boxes not selected by the player is conducted, such lottery of the payouts is conducted before the player selects the element in the slot machine 1 according to the first embodiment. Therefore, in a case that any one of treasure boxes is selected, the lottery of the payouts of remaining two treasure boxes are conducted beforehand taking all patterns into consideration, so that there will occur no problem even if any of the treasure boxes 126˜128 is selected hereinafter by the player. Concretely, at first, it is conducted the first display payout lottery process in which the lottery of the payouts of the second treasure box 127 and the third treasure box 128 is conducted by supposing that the first treasure box 126 is selected. Next, it is conducted the second display payout lottery process in which the lottery of the payouts of the first treasure box 126 and the third treasure box 128 is conducted by supposing that the second treasure box 127 is selected. And it is conducted the third display payout lottery process in which the lottery of the payouts of the first treasure box 126 and the second treasure box 127 is conducted by supposing that the third treasure box 128 is selected.

For example, in the payout lottery process in S11, in a case that the payout of “30” is corresponded to the first treasure box 126, the payout of “15” is corresponded to the second treasure box 127 and the payout of “1” is corresponded to the third treasure box 128, two random number values are sampled through the random number sampling circuit 119 in the first display payout lottery process and the display payout (any of “JP”, “30”, “15”, “5”, “1”) is respectively allotted to each of the second treasure boxes 127 and the third treasure box 128 (both are displayed later) by using the random number values sampled and the display payout lottery table 82 (see FIG. 8). For example, if the random number values sampled are “139” and “60”, the display payout of “5” is corresponded to the second treasure box 127 and the display payout of “15” is corresponded to the third treasure box 128.

Similarly to the above, in the second display payout lottery process, two random number values are sampled through the random number sampling circuit 119 and the display payout (any of “JP”, “30”, “15”, “5”, “1”) is respectively allotted to each of the first treasure boxes 126 and the third treasure box 128 (both are displayed later) by using the random number values sampled and the display payout lottery table 83 (see FIG. 8). For example, if the random number values sampled are “45” and “141”, the display payout of “5” is corresponded to the first treasure box 126 and the display payout of “1” is corresponded to the third treasure box 128. Here, in particular, as for the first treasure box 126, the payout of “5” lower than the payout of “30”, which is corresponded to the first treasure box 126 in the payout lottery process in S11 and is used when the player selects the treasure boxes, is newly corresponded to the first treasure box 126 and such new payout is displayed later (S18). As a result, it can be displayed as if the payout lower than the payout of “15” is corresponded to the first treasure box 126 to which the payout inherently higher than the payout of “15” corresponding to the second treasure box 127 which is selected by the player is corresponded. Therefore, it can make the player recognize that the treasure box selected by himself/herself is the element having high payout. Thereby, accomplishment feeling of the player in the bonus game can be improved.

And the payout of “1” is corresponded to the third treasure box 128 and the payout lower than such payout cannot be displayed, therefore the third display payout lottery process is not conducted as mentioned in the above and the lottery result in S11 is directly displayed if the third treasure box 128 is selected. Here, if the payout of “JP” is corresponded to the third treasure box 128, the lottery result in S11 is similarly displayed.

Here, in the display payout lottery process in S12 may be conducted, the lottery of the display payout may be conducted only for two remaining treasure boxes factually not selected by the player after the player selects the treasure boxes 126˜128 (after process of S16) without conducting such lottery before selection thereof.

Next, in S13, the effect screen 125 of the bonus game is displayed on the lower liquid crystal display 4 by using whole plane including the variable display portions 6 to 8. FIG. 11 is an explanatory view showing the effect screen 125 of the bonus game displayed on the lower liquid crystal display 4 after the bonus game is started.

Here, the effect screen 125 of the bonus game displayed on the lower liquid crystal display 4 after the bonus game is started, is constructed from a 3D (three dimensional) image showing an inner passage of building as shown in FIG. 11 and it is displayed a state that scene is gradually moved toward the inner direction within the inner passage displayed for a predetermined time (for example, 10 seconds).

And in S14, it is determined whether or not the predetermined time (10 seconds in the first embodiment) elapses after the bonus game is started, and if it is determined that the predetermined time does not elapse (S14: NO), the effect screen 125 of the bonus game shown in FIG. 11 is continuously displayed. On the other hand, if it is determined that the predetermined time elapses (S14: YES), procedure shifts to S15.

Next, in S15, the treasure boxes 126˜128, which are the elements, are displayed on the effect screen of the bonus game. FIG. 12 is an explanatory view showing the effect screen 125 of the bonus game displayed on the lower liquid crystal display 4 when the treasure boxes 126˜128 are displayed in the bonus game.

Further, in S16, the CPU 61 determines whether or not any one of the treasure boxes 126˜128 is selected. Concretely, the CPU 61 determines whether or not the player touches by a finger any one of the treasure boxes 126˜128 displayed on the lower liquid crystal display 4 based on the coordinate position information transmitted from the touch panel drive circuit 99, and further the CPU 61 specifies which treasure box 126˜128 is selected.

And if it is determined that any one of the treasure boxes 126˜128 is not selected (S16: NO), procedure waits till any one of the treasure boxes 126˜128 is selected. On the other hand, if it is determined that any one of the treasure boxes 126˜128 is selected (S16: YES), procedure shifts to S17.

In S17, on the effect screen 125 of the bonus game displayed on the lower liquid crystal display 4, the payout 130 (for example, numeral such as “15” or “30” indicating the credits which are paid out) and an item 131 corresponding to the payout (for example, “crown” for payout of “JP”, “treasure sword” for payout of “30”, “holy cup” for payout of “15”, “necklace” for payout of “5”, “bracelet” for payout of “1”) are newly displayed on the treasure box selected by the player. Here, as the payout 130, the payout corresponded on the basis of the lottery result in the lottery done in S11 is displayed. FIG. 13 is an explanatory view of the effect screen 125 of the bonus game when the payout 130 corresponding to the treasure box selected by the player is displayed.

As shown in FIG. 13, for example, in the payout lottery process in S11, in a case that the payout of “30” is corresponded to the first treasure box 126, the payout of “15” is corresponded to the second treasure box 127 and the payout of “1” is corresponded to the third treasure box 128 and the player selects the second treasure box 127, the payout 130 of “15” and the item 131 of “holy cup” are displayed on the second treasure box 127. And the display state of the treasure box 127 is changed to the state that a cover of the treasure box 127 is opened.

Next, in S18, on the effect screen 125 of the bonus game displayed on the lower liquid crystal display 4, the payouts 132 and 134 and the items 133 and 135 corresponding to the payouts are newly displayed on two remaining treasure boxes which are not selected by the player. Here, as the payouts 132 and 134, the display payouts corresponded on the basis of the lottery result in S12 are displayed, except for a case that the player selects the treasure box corresponded to the payout of “JP” or “1”. On the contrary, if the player selects the treasure box corresponded to the payout of “JP” or “1”, the payout corresponded on the basis of the lottery result in S11 is directly displayed. Here, FIG. 14 is an explanatory view showing the effect screen 125 of the bonus game when the payouts 132, 134 corresponded to the treasure boxes not selected by the player are displayed.

As shown in FIG. 14, for example, in the payout lottery process in S11, in a case that the payout of “30” is corresponded to the first treasure box 126, the payout of “15” is corresponded to the second treasure box 127 and the payout of “1” is corresponded to the third treasure box 128 and the display payout of “5” is corresponded to the first treasure box 126 and the display payout of “12 is corresponded to the third treasure box 128 in the second display payout lottery process of the display payout lottery process of S12, and further the player selects the second treasure box 127 in S16, the payout 132 of “5” and the item 133 of “necklace” are displayed on the first treasure box 126. And the payout 134 of “1” and the item 135 of “bracelet” are displayed on the third treasure box 128. And the display state of the treasure boxes 126 and 128 is changed to the state that covers of the treasure box 126 and 128 are opened.

And in S19, a payout addition process in the bonus game is conducted. In this payout addition process, the payout corresponding to the treasure box which is selected (credits corresponding to the payout displayed in S17) and the payout of the base game in S4 are mutually added and stored. The added payout is paid out with the payout of the base game in the payout process of S5 mentioned later. Thereafter, the bonus game is terminated and procedure returns to the main process program.

As mentioned in the above, in the slot machine 1 according to the first embodiment, each of the payouts (any one of “JP”, “30”, “15”, “5”, “1”) is corresponded to each of thee treasure boxes 126˜128 (see FIG. 12) which are elements of the bonus game displayed on the effect screen 125 in the bonus game (S11), and the payout, which is different from the payout corresponded by the bonus payout lottery table 81 (concretely, display payout for displaying to the player, such payout being different from the payout when the treasure box is selected) is newly corresponded to two treasure boxes not selected by the player by using the display payout lottery tables 28 to 84 (S12), while taking beforehand all conceivable selection patterns (in the first embodiment, three selection patterns in which there are a case that the first treasure box 126 is selected, a case that the second treasure box 127 is selected and a case that the third treasure box 128 is selected) into consideration. Further, after the player selects any one of the treasure boxes 126˜128, the payouts of the treasure box which is selected and the treasure boxes which are not selected are displayed, respectively (S17, S18). Therefore, as for the payouts corresponding to the elements (treasure boxes 126˜128) not selected by the player, it can make the player recognize as if the display payouts displayed later are already corresponded to the elements at the time that the player selects one of the elements. Thereby, for example, it can be displayed after the treasure box is selected as if the payout lower than that corresponded to the treasure box selected is corresponded to the treasure box to which the payout inherently higher than the payout corresponding to the treasure box selected by the player is corresponded. Accordingly, it can make the player recognize that the treasure box selected by himself/herself is the element with high payout, as a result, accomplishment feeling of the player in the bonus game can be improved.

### Second Embodiment

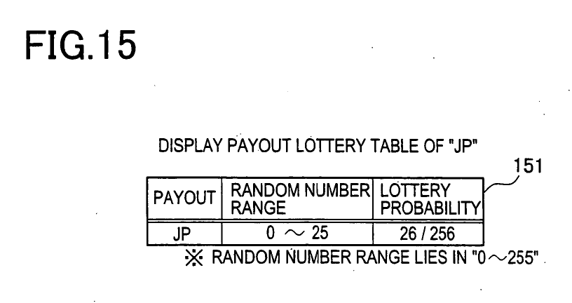

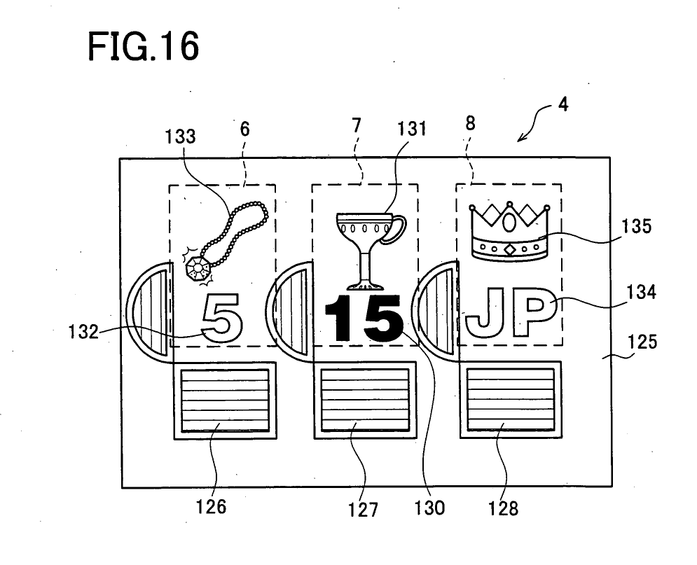

Next, the slot machine according to the second embodiment will be described with reference to FIGS. 15 and 16. Here, in description described hereinafter, the marks (numbers), which are as same as those in the construction of the slot machine 1 according to the first embodiment shown in FIGS. 1 to 14, indicate the construction or elements which are as same as those in the slot machine 1 of the first embodiment.

The outline construction of the slot machine in the second embodiment is substantially as same as that in the slot machine 1 in the first embodiment. And various control processes in the second embodiment are substantially as same as those in the slot machine 1 of the first embodiment.

Here, although in the slot machine 1 of the first embodiment the lottery is conducted in the display payout lottery process of S12 by using the display payout lottery tables 28 to 84 so that the payout lower than the payout corresponding to the element (treasure box 126˜128) selected by the player is displayed as the payout of the element not selected by the player, the slot machine of the second embodiment is different from the slot machine 1 of the first embodiment at the point that the lottery is conducted by using the display payout lottery tables 82 to 84 so that the payout of “JP” higher than the payout corresponding to the element (treasure box 126˜128) selected by the player is displayed as the payout of the element not selected by the player.

Here, FIG. 15 is an explanatory view showing a display payout lottery table 151 of the slot machine according to the second embodiment. In the slot machine of the second embodiment, in the display payout lottery process of the bonus game in S12, the payout of “JP” is newly corresponded with a high probability to the treasure box as the element not selected by the player, thereby the payout of “JP”, which is scarcely corresponded to the element in the lottery using the general bonus payout lottery table 81, is displayed as the payout corresponding to the element (S18).

As shown in FIG. 15, if the random number value sampled within a range of “0˜255” through the random number sampling circuit 119 lies in a range of “0˜25”, the payout at the time that the treasure box is selected is changed and displayed as if the payout of “JP” is corresponded to the treasure box beforehand.

And in the display payout corresponded to the treasure boxes 126˜128 by the display payout lottery table 151, the probability corresponded to the payout of “JP” is raised such as 1/256˜26/256, in comparison with the bonus payout lottery table 81. Therefore, it can make the player recognize as if the payout of “JP”, in which the probability corresponded to the element is the lowest and which is scarcely displayed as the payout, is corresponded to the other treasure box at the time that the treasure box is selected. Thereby, expectation for the bonus game conducted in the future can be given to the player, thus game motivation of the player can be improved.

Hereinafter, the payout lottery process of S11 and the display payout lottery process of S12 conducted in the slot machine of the second embodiment will be concretely described. At first, in the payout lottery process of S11, three random number values are sampled through the random number sampling circuit 119, similar to the slot machine 1 of the first embodiment, and one of the payouts (any one of “JP”, “30”, “15”, “52, “1”) is allotted to each of the treasure boxes 126˜128 (see FIG. 12) displayed later by using the random number values sampled and the bonus payout lottery table 81 (see FIG. 8).

And in the display payout lottery process of S12, two random number values are sampled through the random number sampling circuit 119 and the display payout of “JP” is allotted with a predetermined probability to the treasure boxes (for example, the first treasure box 126 and the third treasure box 128 if the second treasure box 127 is selected) which are not selected by using the sampled random number values and the display payout lottery table 151. For example, if the random number values are “139” and “20”, the payout of the treasure box positioned at the left side among the remaining treasure boxes is not changed and the display payout of “JP” is corresponded to the treasure box positioned at the right side.

And in S18, on the effect screen 125 of the bonus game displayed on the lower liquid crystal display 4, the payouts 132, 134 and the items 133, 135 corresponding to the payouts are newly displayed on two remaining treasure boxes not selected by the player. At that time, if the display payout of “JP” is corresponded on the basis of the lottery result in S12, the payout of “JP” is displayed on the treasure box corresponded thereto. FIG. 16 is an explanatory view showing the effect screen 125 of the bonus game when the payouts 132, 134 corresponding to the treasure boxes not selected by the player are displayed, in the slot machine of the second embodiment.

As shown in FIG. 16, for example, in the payout lottery process of S11, in a case that the payout of “5” is corresponded to the first treasure box 126, the payout of “15” is corresponded to the second treasure box 127 and the payout of “1” is corresponded to the third treasure box 128 and the payout of “JP” is corresponded to the treasure box positioned at the right side, and further the player selects the second treasure box 127, the payout 132 of “5” and the item 133 of “necklace” are displayed on the first treasure box 126 and the payout 134 of “JP” and the item 135 of “crown” are displayed on the third treasure box 128. Thereby, it can make the player recognize as if the payout of “JP” is corresponded to the other treasure box at the time that the treasure box is selected.

As mentioned in the above, in the slot machine 1 of the second embodiment, each of the payouts (any one of “JP”, “30”, “15”, “5”, “1”) is corresponded to each of three treasure boxes 126˜128 (see FIG. 12) which are elements of the bonus game displayed on the effect screen 125 in the bonus game (S11), and the payout of “JP” as the payout for displaying the payout of “JP” to the player with a predetermined probability is newly corresponded to two treasure boxes not selected by the player by using the display payout lottery table 151 (S12). Further, after the player selects any one of the treasure boxes 126˜128, the payouts of the treasure box which is selected and the treasure boxes which are not selected are displayed, respectively (S17, S18). Therefore, for example, it can make the player recognize as if the payout of “JP”, in which the probability corresponded to the element is the lowest and which is scarcely displayed as the payout, is corresponded to the other treasure box at the time that the treasure box is selected. Thereby, expectation for the bonus game conducted in the future can be given to the player, thus game motivation of the player can be improved.

Here, the present invention is not limited to the embodiments and various modifications, changes can be done within the scope of the present invention.

For example, in the slot machine of the first and the second embodiments, although in the payout lottery process of S11 in the bonus game three random number values are sampled and the payout is corresponded beforehand to each of the treasure boxes 126˜128 which are the elements, thereby the payout finally obtained by the player based on the selection result of the element done later by the player is determined, it may be conceivable that only one random number value is sampled and the player obtains the same payout, in spite that the player selects which treasure box. At that time, the slot machine is controlled so that the display payouts for two remaining treasure boxes (not selected by the player) to which the payouts are not corresponded in the display payout lottery process of S12 are determined by a lottery while using the display payout lottery tables 82˜84, 151.

And in the slot machine of the first and the second embodiments, although the player selects one treasure box among three treasure boxes 126˜128 in the selection process of the element in the bonus game, the player may select two treasure boxes and total payouts may be paid out. At that time, the slot machine is controlled so that in the display payout lottery process of S12, only display payout for one remaining treasure box not selected is determined by a lottery while using the display payout lottery tables 82˜84, 151.

And in the slot machine of the first and the second embodiments, although in the display payout lottery process of S12 in the bonus game the lottery of the display payouts for two remaining treasure boxes, which are elements not selected by the player, is again conducted by using the display payout lottery tables 82˜84, 151, the lottery of the display payout for only one treasure box as one of the elements among the elements not selected may be conducted by using the display payout lottery tables 82˜84, 151.

Further, in the slot machine of the first and the second embodiments, although it is used the payout according to which a predetermined amount of credits is paid out as the payout in the bonus game, any award may be given to the player as the payout. For example, such payout may be an award that the free game can be conducted in plural times.

And in the first and the second embodiments, although the lottery of the winning symbol combination is conducted based on the lottery table shown in FIG. 4, the lottery of the stop symbol may be conducted every variable display portion 6˜8.

Concretely, it is provided a table in which each symbol in the symbol columns 42 to 44 used in the game and variably displayed in each of the variable display portions 6 to 8 and a code No. are mutually corresponded, and it is provided a lottery table in which the code No. of the symbol in each symbol column and the random number value are corresponded. And the lottery of the symbol stopped on the pay line L is conducted every each of the variable display portions 6 to 8, and the winning symbol combination is detected based on the stop symbols. In a case that the winning symbol combination is won, the payout corresponding to the winning symbol combination is paid out. The base game is done according to the above.

And although the present invention is explained according to the embodiments while indicating the slot machine in which the base game and the bonus game are conducted as the gaming machine, it is enough that the gaming machine can conduct the selection type bonus game in addition to the base game. For example, the present invention can be, of course, adopted for a gaming machine that it is conducted a game such as a roulette game or a bingo game in which many players can participate.

What is claimed is:

1. A gaming machine comprising:
an image display device for displaying images thereon;
an operation device;
a first game control device for controlling a first game;
a second game control device for executing a second game which is executed continuous to the first game when a predetermined condition is realized in the first game;
wherein the second game control device comprises:
an element display device for displaying plural elements on the image display device;
an element specification device for specifying the element among plural elements displayed on the image display device based on an operation of the operation device;
a first payout lottery device for conducting a lottery of the payouts corresponding to the elements displayed on the image display device by using a first lottery manner;
a first element payout display device for displaying on the image display device the payout corresponding to the element specified through the element specification device based on a lottery result of the first payout lottery device;
a second payout lottery device for conducting a lottery of the payouts corresponding to the elements not specified through the element specification device by using a second lottery manner different from the first lottery manner;
a second element payout display device for displaying on the image display device the payouts corresponding to the elements not specified through the element specification device based on a lottery result of the second payout lottery device; and
an award giving device for giving an award corresponding to the payout displayed on the image display device through the first element payout display device.

2. The gaming machine according to claim 1, wherein the first payout lottery device corresponds the payout to each of the elements before the element is specified through the element specification device.

3. The gaming machine according to claim 1, wherein the second payout lottery device changes the second lottery manner based on the payout corresponding to the element specified through the element specification device.

4. The gaming machine according to claim 3, further comprising:
a first lottery table used when the first payout lottery device conducts the lottery of the payouts;
a plurality of second lottery tables each of which corresponds to each of the elements specified through the element specification device, each of the second lottery tables being used when the second payout lottery device displays the payouts corresponding to the elements not specified through the element specification device except for the element specified through the element specification device.

5. The gaming machine according to claim 4, wherein the second payout lottery device changes the second lottery manner by changing the second lottery table corresponding to the element specified through the element specification device.

6. The gaming machine according to claim 1, wherein a probability that the payout lower than the payout corresponding to the element specified through the element specification device is corresponded to the element not specified therethrough is set higher in the second payout lottery device than the probability in the first payout lottery device.

7. The gaming machine according to claim 1, wherein a probability that the payout corresponded to the element with a lowest probability in the first payout lottery device is corresponded to the element in the second payout lottery device is set higher in the second payout lottery device than the probability in the first payout lottery device.
